(19) United States
(12) Patent Application Publication
(10) Pub. No.: US 2026/0188332 A1
(43) Pub. Date: Jul. 2, 2026

(54) HYBRID MASKING THRESHOLD-BASED PERCEPTUAL SLACK FOR AUDIO WATERMARKING

(71) Applicant: HARMAN INTERNATIONAL INDUSTRIES, INCORPORATED, Stamford, CT (US)

(72) Inventors: Anshuman GANGULY, Commerce, MI (US); Kevin J. BASTYR, Franklin, MI (US); Anton KOVALYOV, Farmington Hill, MI (US)

(21) Appl. No.: 19/202,384

(22) Filed: May 8, 2025

Related U.S. Application Data
(60) Provisional application No. 63/739,388, filed on Dec. 27, 2024.

(51) Int. Cl. G10L 19/018

(52) U.S. Cl. CPC G10L 19/018

(57) ABSTRACT

Techniques are described for hybrid masking threshold-based perceptual slacks for audio watermarking. In some embodiments, the techniques include identifying an audio signal, determining perceptual slacks for the audio signal, generating a watermarked audio signal that includes an audio watermark based on the perceptual slacks, and outputting the watermarked audio signal using one or more speakers, for localization of the one or more speakers.

### CROSS-REFERENCE TO RELATED APPLICATIONS

This application claims the benefit of U.S. Provisional patent application titled, “HYBRID MASKING THRESHOLD-BASED PERCEPTUAL SLACK FOR AUDIO WATERMARKING,” filed on Dec. 27, 2024, and having Ser. No. 63/739,388. The subject matter of this related application is hereby incorporated herein by reference.

### BACKGROUND

### Field of the Various Embodiments

This application relates to techniques for audio processing, and more specifically, to hybrid masking threshold-based perceptual slack for audio watermarking.

### Description of the Related Art

Audio systems utilize wide varieties of techniques to achieve post processing effects for the end user experience. The effects can include loss compensation, mixing different signals, adding effects to create an audio atmosphere, and so on. The audio systems can use speaker positions to improve accuracy efficacy of the effects. Speaker or acoustic device localization refers to identifying the positions of speakers of an audio system. However, some speaker localization procedures require end-user input such as manually inputting and/or adjusting the speaker locations. One automated solution for speaker localization is to perform a calibration procedure. The calibration procedure typically includes a first device using one more speakers to output an acoustically detectable signal that is captured by one or more microphones of a second device. Using knowledge of the acoustically detectable signal and the captured signal, information about the relative locations of the first and second devices can be determined. Many calibration procedures typically produce a sine sweep or a series of test sounds that are audible to users. Users often find the sine sweeps or test sounds too intrusive to complete and may forego the calibration procedure. As a result, the audio systems fail to produce the desired effects or operate at a reduced efficacy.

Audio systems also utilize audio watermarking, or adding a computer-recognizable sound pattern or audio watermark to an audio signal. Typically, watermarks are used to identify copyrighted or otherwise protected recordings to detect unauthorized use. Ideally, audio watermarks would be imperceptible to the ear. However, one drawback of existing techniques is that the audio watermarks that are imperceptible for humans and other listeners are difficult for an audio or computer system to detect or recognize from microphone-recorded audio. Watermarks that are imperceptible to the ear cause failures for audio systems that detect the audio watermarks.

As a result, some conventional audio watermarking such as modulated complex lapped transform (MCLT)-based audio watermarking, the phase of the audio signal is modified to either be 0° or 180°. However, this aggressive phase shift causes users to perceive MCLT phase modulation at certain frequencies. Other watermarking systems use exponentially smoothed phase modulation (ESPM). ESPM allows watermarking over a wider frequency band, which specifically includes lower frequency regions where conventional MCLT-based watermarking cannot be applied in an imperceptible manner. However, in the ESPM scheme, the phase modifications only vary across carrier frequencies, but stay constant across time. Each time frame receives the same amount of phase modulation compared to the adjacent frames, reducing the utility of the watermark. Typically, improving imperceptibility comes at the cost of degrading robustness, especially for lower frequency band embedding.

As the foregoing illustrates, what is needed in the art is improved techniques for audio watermarking and effects processing.

### SUMMARY

One embodiment of the present disclosure sets forth a method that includes receiving an audio signal, analyzing the audio signal to determine a perceptual slack of the audio signal, determining one or more audio watermarks to modify the audio signal based on the perceptual slack, adding the one or more audio watermarks to modify the audio signal to generate a watermarked audio signal, and outputting the watermarked audio signal using one or more speakers.

At least one technical advantage of the disclosed techniques relative to the prior art is that the disclosed techniques enable localization of audio devices such as speakers using audio watermarking that is audibly imperceptible to a listener. Specifically, the disclosed techniques increase the detectability of audio watermarks while keeping the watermark imperceptible to a listener. This enhanced watermarking improves localization, thereby improving audio quality and efficacy of effects produced by the system. The disclosed techniques also enable imperceptible speaker localization without user intervention or initiation, ensuring that the system completes the localization. The disclosed techniques further provide time-variant and frequency-variant imperceptible watermarking.

These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a schematic diagram illustrating an audio system according to various embodiments;

FIG. 2 is a diagram illustrating the operation of the perceptual slack module of FIG. 1, according to various embodiments;

FIG. 3 is a graph illustrating phase depths of audio generated using the audio watermarking module of FIG. 1, according to various embodiments;

FIG. 4 is another graph illustrating phase depths of audio generated using the audio watermarking module of FIG. 1, according to various embodiments;

FIG. 5 is a flow diagram of method steps for determining perceptual slack, according to various embodiments.

FIG. 6 is a flow diagram of method steps for determining a transition frequency value, according to various embodiments.

FIG. 7 is a flow diagram of method steps for determining a slack value for frequencies greater than the transition frequency value, according to various embodiments.

FIG. 8 is a flow diagram of method steps for modifying audio effects, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

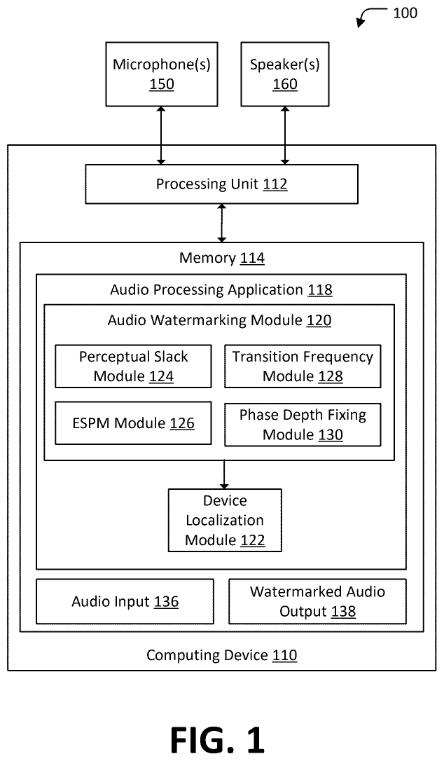

FIG. 1 is a schematic diagram illustrating an audio system 100 according to various embodiments. As shown, the audio system 100 includes, without limitation, one or more computing devices 110 and one or more speakers 160. A computing device 110 includes, without limitation, one or more processing units 112 and one or more memories 114. In various embodiments, an interconnect bus (not shown) connects the one or more processing units 112, the one or more memories 114, the speakers 160, and any other components of the computing device 110. The one or more memories 114 store, without limitation, an audio processing application 118, an audio watermarking module 120, a device localization module 122, perceptual slack module 124, an ESPM module 126, a transition frequency module 128, a phase depth fixing module 130, an audio input 136, and a watermarked audio output 138. While shown as submodules of the audio processing application 118, the audio watermarking module 120 and the device localization module 122 can include executable instructions that work in concert with the audio processing application 118 as submodules and/or separate software modules. While shown as submodules of the audio watermarking module 120, the perceptual slack module 124, the ESPM module 126, the transition frequency module 128, and/or the phase depth fixing module 130 can include executable instructions that work in concert with the audio watermarking module 120 as submodules and/or separate software modules.

In various embodiments, the one or more computing devices 110 are included in any feasible audio system, such as a vehicle audio system, a home theater system, a soundbar and/or the like. In some embodiments, one or more computing devices 110 are included in one or more devices, such as consumer products (e.g., portable speakers, gaming, etc. products), vehicles (e.g., the head unit of an automobile, truck, van, etc.), smart home devices (e.g., smart lighting systems, security systems, digital assistants, etc.), communications systems (e.g., conference call systems, video conferencing systems, speaker amplification systems, etc.), and so forth. In various embodiments, one or more computing devices 110 are located in various environments including, without limitation, indoor environments (e.g., living room, conference room, conference hall, home office, etc.), and/or outdoor environments, (e.g., patio, rooftop, garden, etc.). The computing device 110 is also able to provide audio signals (e.g., generated using the audio processing application 118) to speaker(s) 160 or other audio devices to generate a sound field that provides various audio effects.

The one or more processing units 112 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of different processing units, such as a CPU configured to operate in conjunction with a GPU and/or a DSP. In general, a processing unit 112 can be any technically feasible hardware unit capable of processing data and/or executing software applications.

Memory 114 can include a random-access memory (RAM) module, a flash memory unit, or any other type of memory unit or combination thereof. Processing units 112 are configured to read data from and write data to the memory 114. In various embodiments, a memory 114 includes non-volatile memory, such as optical drives, magnetic drives, flash drives, or other storage. In some embodiments, separate data stores, such as an external data stores included in a network (“cloud storage”) can supplement the memory 114.

The speakers 160 include various speakers and other audio devices for outputting audio to create the sound field or the various audio effects in the vicinity of the user. The audio effects can include spatial up-mixing and other effects. In some embodiments, the speakers 160 are associated with a speaker configuration that includes speaker locations identified using the device localization module 122 and stored in the memory 114. The speaker configuration indicates locations and/or orientations of the speakers 160 in a three-dimensional space and/or relative to one another and/or relative to a microphone 150, a vehicle, a vehicle seat, a gaming chair, a particular one of the speakers 160, the computing device 110, a location of a user, and/or the like.

The audio processing application 118 retrieves or otherwise identifies the speaker configuration of the speakers 160 to apply certain effects to audio produced using the speakers 160. The audio processing application 118 identifies an audio input 136. The audio processing application 118 retrieves the audio input 136 from the memory 114 and/or receives the audio input 136 over a network such as a local area network or a wide area network. The audio processing application 118 processes the audio input 136 according to time frames or discrete time segments. The audio processing application 118 also separates each time frame of the audio input 136 into a set of frequency bins. Each frequency bin has a configured bandwidth and a configured center frequency. In some embodiments, the frequency bins are regularly spaced with a particular bandwidth of frequencies for each bin. In other embodiments, the frequency bins are spaced according to Bark scale frequency bands or another perceptual scale of frequency bands where bandwidths of at least two frequency bands differ from one another, and center frequencies of at least two frequency bands differ from one another.

The audio watermarking module 120 applies the audio watermark based on perceptual slack of the audio input 136. Perceptual slack refers to specifically determined amounts of phase shifts or modified phases that can be embedded into an audio signal without being detectable by a listener. The audio watermarking module 120 determines an estimate of the maximum allowable sound pressure level (SPL) for each carrier frequency bin for each time frame to calculate an amount of phase shift that can be applied or embedded for a frequency and/or frequency bin. The audio watermarking module 120 uses this phase embedding scheme to enable automatic content-dependent control of phase shifts. In some embodiments, the audio watermarking module 120 determines and applies a phase depth for each frequency bin of a time frame and redetermines these frequency bin variant phase depths for each time frame. A particular frequency bin for a particular time frame can be referred to as a time-frequency bin. The phase depths are determined based on a perceptual slack of each time-frequency bin of the audio input 136. As a result, the phase depth of the audio watermark is time variant, frequency variant, and is based on the perceptual slack. In some embodiments, the audio watermarking module 120 converts a global masking threshold into an angular value indicating estimated perceptual slack (e.g., using perceptual slack module 124), identifies ESPM-based phase shifts (e.g., using ESPM module 126), and multiplies or otherwise utilizes the ESPM-based phase shift and the estimated perceptual slack for each time-frequency bin to determine a phase depth for each time-frequency bin. The ESPM-based phase shifts vary with frequency, but are invariant across time frames. By contrast, the phase depths for the time-frequency bins of the present disclosure are time variant and frequency variant. In further embodiments, the audio watermarking module 120 identifies a frequency and/or frequency bin index k_{c} (e.g., using transition frequency module 128), and sets a constant or maximum phase depth for all frequencies or frequency bins above k_{c}. The constant or maximum phase depth can be configured as any desired value. In some embodiments, the audio watermarking module 120 identifies a fixed phase depth Vₘ that is applied above frequency bin index k_{c} using an iterative process (e.g., using phase depth fixing module 130).

Device localization module 122 uses the watermarked audio output 138 and detected audio that is measured using the microphones 150 to identify speaker locations and/or orientations of the speakers 160 in a three-dimensional space and/or relative to one another and/or relative to a microphone 150, a vehicle, a vehicle seat, a gaming chair, a particular one of the speakers 160, the computing device 110, a location of a user, and/or the like. For example, the device localization module 122 compares the known phase depths of the watermarked audio output 138, as determined by the audio watermarking module 120, to the detected audio that is measured using the microphones 150. Device localization module 122 determines speaker locations and/or orientations of the speakers 160 in a three-dimensional space based on the comparison.

The perceptual slack module 124 identifies angular values vₙ(k,i) denoting estimated perceptual slack, where i represents a time frame and k represents a frequency bin index. The perceptual slack module 124 identifies angular values vₙ(k,i) based on global masking threshold (GMT)T_{g}. In some embodiments, perceptual slack module 124 identifies GMT T_{g} according to equation (1), and angular perceptual slack values vₙ(k,i) according to equation (2):

$${T}_{g} ( k , i ) = {T}_{q} + \sum {T}_{t} ( k , i ) + \sum {T}_{n t} ( k , i ) \qquad ( 1 )$$

$${v}_{n} ( k , i ) = 2 arcsin ( \frac{{T}_{g} ( k , i )}{2 A ( i )} ) \qquad ( 2 )$$

In equation (1), T_{q} is absolute hearing threshold (AHT), which is specified in dB. AHT is the sound pressure level of a pure tone that is at the edge of audibility, as a function of frequency. Normalization of AHT is done by adjusting T_{q} such that a signal with a frequency of 4 kHz (or another value) and an amplitude of +1 lower side band (LSB) (−96 dB or another configured value) lies on the curve of the absolute threshold, corresponding to T_{q}. If the computed GMT lies below the AHT, the perceptual slack module 124 sets a masking threshold to the absolute threshold for each frequency bin per time frame. This quantity can be pre-computed based on the frequency bin of interest in kHz and sampling rate and stored in a lookup table. Tₜ represents the individual masking thresholds for each tonal component. Tₙₜ represents the individual masking thresholds for each non tonal component. In this context, a component refers to a time-frequency component corresponding to a particular time frame i and a particular frequency bin k. A tonal component is a sinusoid-like component that is dominated by or associated with a tone of a particular frequency, and a non-tonal component is noise-like in that a particular tone does not dominate. The tonal components are identified as local maxima (e.g., of sound pressure amplitude) by comparing the relative amplitudes of the spectrum over adjacent frequency bins, which includes setting a power threshold (e.g., 7 dB or any configured threshold) around a sliding widow of a specified size (e.g., 4 bins or any configured value), according to equation (3). Equation (3) describes a filter fₜ(i) that selects a bin index k corresponding to a maximum sound pressure level amplitude A(k,i) of MCLT coefficients in the k^{th} bin index and i^{th} time frame index.

$${f}_{t} ( i ) = arg {max}_{i ∈ N , k ∈ K} A ( k , i ) \qquad ( 3 )$$

In equation (3), N is a fixed but configurable number N of time frames i that are compared, and K is a fixed but configurable number of frequency bins k.

The ESPM module 126 performs an ESPM analysis of the audio input 136. The ESPM module 126 identifies a set of ESPM-based phase shifts based on at least a portion of the audio input 136. The ESPM-based phase shifts vary with frequency, but are invariant across time frames of the audio input 136.

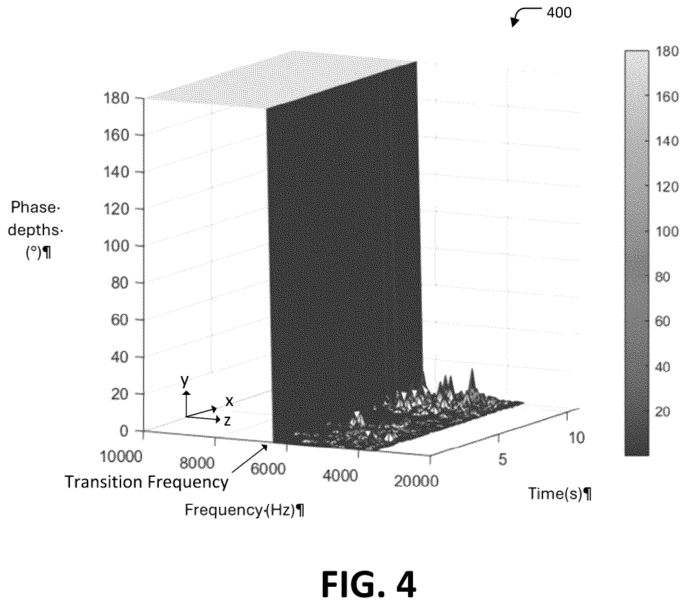

The transition frequency module 128 determines frequency and/or frequency bin index k_{c} using an iterative process described in greater detail with respect to FIG. 4. In some examples, k_{c} is constant across multiple time frames. However, in other examples, k_{c} is recalculated for each time frame. Above frequency bin index k_{c}, the audio watermarking module 120 applies a constant phase depth above the frequency and/or frequency bin index k_{c}.

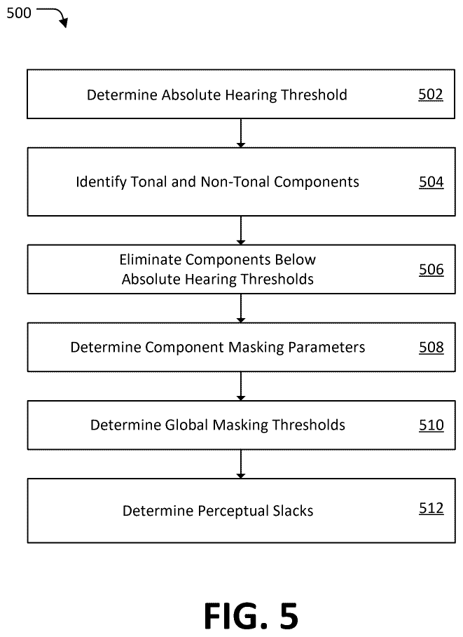

The phase depth fixing module 130 determines fixed phase depth Vₘ that is applied above frequency bin index k_{c}, using an iterative process described in greater detail with respect to FIG. 5. In some examples, fixed phase depth Vₘ is constant above k_{c} and constant across multiple time frames. However, in other examples, fixed phase depth Vₘ is constant above k_{c} and recalculated for each time frame.

The audio input 136 includes any feasible signal or data that includes audio. The audio input 136 includes an audio, video, multimedia, or other data file, stream, and/or the like. In some embodiments, the audio system 100 receives the audio input 136 over a network such as a local area network or a wide area network. The network can include a public and/or private network. The audio system 100 durably and/or temporarily stores the audio input 136 in the memories 114. In some embodiments, the audio processing application 118 processes the audio input 136 in discrete time chunks or segments. The audio processing application 118 segments the audio input 136 into discrete and uniformly spaced time segments according to units of time for processing. The audio processing application 118 also separates the audio input 136 into frequency bins as discussed above.

The watermarked audio output 138 is a processed version of the audio input 136, which is processed to include an audio watermark corresponding to a particular pattern of perceptual slack or phase shifts. While the audio processing application 118 is capable of using the watermarked audio output 138 for device localization, the audio processing application 118 or another computing device can also use the watermarked audio output 138 to identify copyrighted or otherwise protected audio.

Each of the one or more microphones 150 can be any technically feasible type of audio input device, such as any type of dynamic, condenser, ribbon or other type of microphone. The one or more microphone(s) 150 capture audio including audio signals watermarked using the techniques or audio watermarking module 120 and/or device localization module 122. The captured audio is provided to device localization module 122.

Each of the one or more speakers 160 can be any technically feasible type of audio outputting device. Each of the one or more speakers 160 outputs audio including audio signals watermarked using the techniques of audio watermarking module 120 and/or device localization module 122.

In one example of operation, the audio system 100 performs audio processing using the audio processing application 118. The audio processing application 118 uses the audio watermarking module 120 to apply an audio watermark. The audio processing application 118 applies one or more audio effects using frequency domain processing, and generates a watermarked audio output 138. The audio processing application 118 provides the watermarked audio output 138 to the speakers 160 to produce a sound field. The audio processing application 118 uses device localization module 122 to identify locations of audio devices such as the speakers 160 or other audio devices. The audio processing application 118 modifies one or more audio effects such as spatial up-mixing based on the locations of the speakers 160.

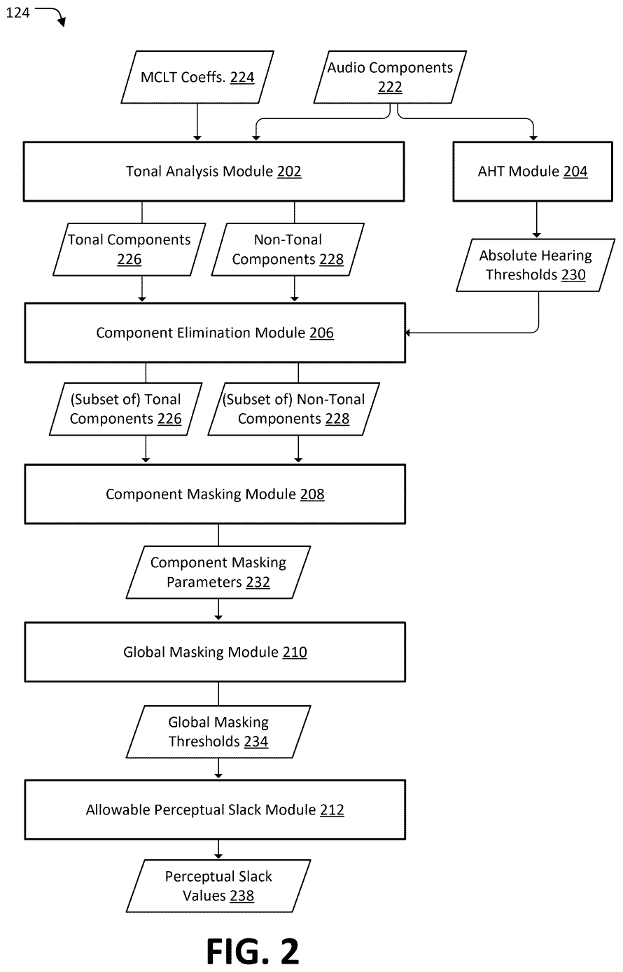

FIG. 2 is a diagram illustrating the operation of the perceptual slack module 124 of FIG. 1, according to various embodiments. As shown, the perceptual slack module 124 includes, without limitation, a tonal analysis module 202, an AHT module 204, a component elimination module 206, a component masking module 208, a global masking module 210, and allowable perceptual slack module 212. Input data for the perceptual slack module 124 includes, without limitation, audio components 222 and MCLT coefficients 224. Intermediate data generated using submodules of the perceptual slack module 124 includes, without limitation, tonal components 226, non-tonal components 228, AHTs 230, respective subsets of the tonal components 226 and non-tonal components 228, component masking parameters 232, and GM Ts 234. Data output from the perceptual slack module 124 includes, without limitation, perceptual slack values 238.

The tonal analysis module 202 receives or identifies input data including audio components 222 of an audio input 136 and MCLT coefficients 224. The audio components 222 are portions of the audio input 136 corresponding to a particular time frames and a particular frequency bin of a set of frequency bins, as discussed with respect to FIG. 1. The tonal analysis module 202 generates tonal components 226 and non-tonal components 228 based on the input data. For example, the tonal analysis module 202 identifies and isolates the tonal components 226 based on the input data. The tonal components 226 are identified as local maxima by comparing the relative amplitudes of an audio component 222 from a particular frequency bin (and time frame) to one or more frequency bins having greater frequencies and one or more frequency bins having lesser frequencies. The tonal components 226 are identified as local maxima based on sound pressure amplitude by comparing the relative amplitudes of the spectrum over adjacent frequency bins, which includes setting a power threshold around a sliding widow of a configured size or number of bins according to equation (3). As indicated with respect to FIG. 1, equation (3) describes a filter fₜ(i) that selects a bin index k corresponding to a maximum sound pressure level amplitude A (k,i) of MCLT coefficients 224 for the audio component 222 of the k^{th} bin index and i^{th} time frame index.

The AHT module 204 identifies AHTs 230 for each audio component 222. In one embodiment, AHT module 204 identifies AHTs 230 as a function of frequency f based on equation (4).

$${T}_{q} ( f ) = 3.64 {f}^{- 0.8} - 6.5 {e}^{- 0.6 {( f - 3.3 )}^{2}} + 1 {0}^{- 3} {f}^{4} \qquad ( 4 )$$

In equation (4), T_{q}(f) is specified in dB, and the frequency f is in kHz. AHT module 204 normalizes AHTs 230 by adjusting equation (4) so that a signal with a frequency of a particular value and an amplitude of ±1LSB (−96 dB) lies on the AHT curve of the AHTs 230 over a range of frequencies.

The component elimination module 206 takes inputs including the tonal components 226 and the non-tonal components 228, and provides outputs including respective subsets of the tonal components 226 and the non-tonal components 228. The component elimination module 206 eliminates the tonal components 226 and the non-tonal components 228 that have sound pressure levels below the sound pressure level of the AHT curve. Accordingly, the component elimination module 206 identifies a subset of the tonal components 226 that is above the sound pressure level of the AHT curve. The component elimination module 206 also identifies a subset of the non-tonal components 228 that is above the sound pressure level of the AHT curve.

The component masking module 208 identifies component masking parameters 232 including individual masking thresholds for each of the subset of tonal components 226 and subset of non-tonal components 228. The component masking module 208 determines component masking parameters 232 including masking power for each of the subset of tonal components 226 and subset of non-tonal components 228 for the corresponding frequency index. The component masking module 208 determines component masking parameters 232 including masking indices for each of the subset of tonal components 226 and subset of non-tonal components 228 for the corresponding frequency index. In one example, the tonal masking indices Vₜ are identified using equation (5), and non-tonal masking indices Vₙₜ are identified using equation (6).

$${V}_{t} [ z ( k ) ] = - 1.525 - 0.275 * z ( k ) - 4.5 \qquad ( 5 )$$

$${V}_{n t} [ z ( k ) ] = - 1.525 - 0.175 * z ( k ) - 0.5 \qquad ( 6 )$$

In equations (5) and (6), k is a frequency bin index and z(k) is the bark frequency corresponding to the k^{th} frequency bin index, for example, for a particular time frame.

The global masking module 210 determines the GM Ts 234 T_{g} based on the component masking parameters 232, for example, according to equation (1). In some embodiments, Tₜ(k, i) is a masking function that is based on Vₜ[z(k)]. In some embodiments, Tₙₜ(k, i) is a masking function that is based on Vₙₜ[z(k)].

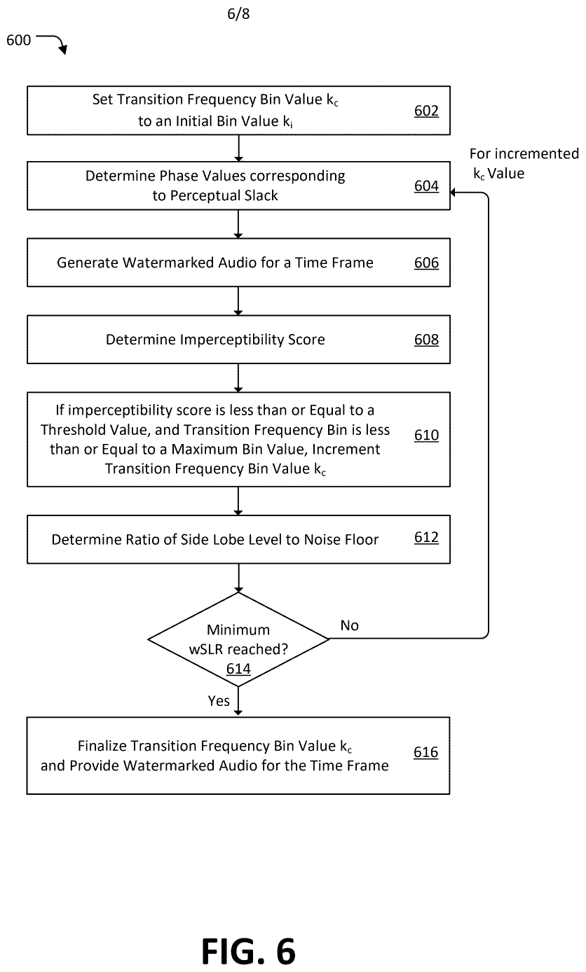

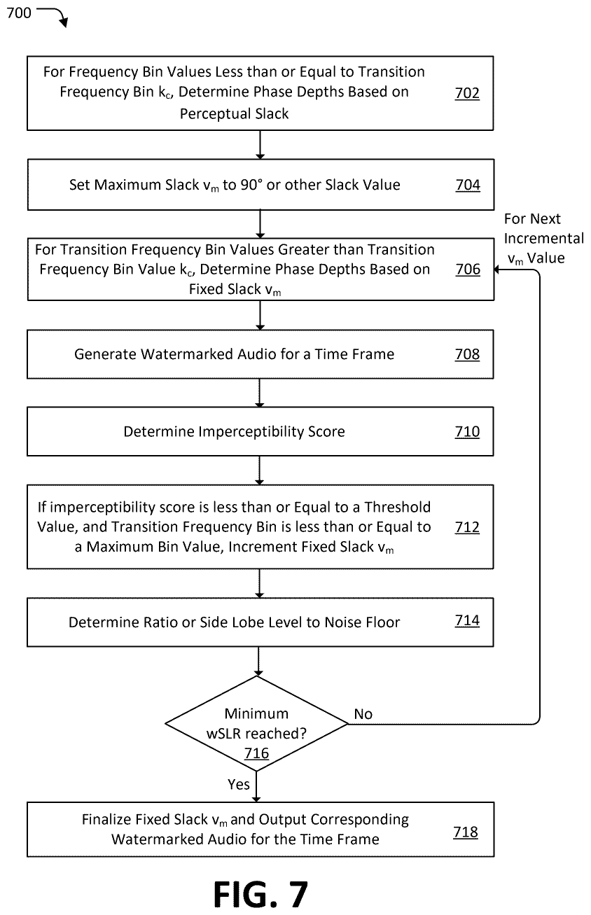

The allowable perceptual slack module 212 determines perceptual slack values 238 that are allowable based on the GMTs 234, for example, according to equation (2). In some embodiments, the allowable perceptual slack module 212 determines perceptual slack values 238 by further combining GMTs 234 with ESPM phase shifts, by multiplying them for each time-frequency bin, followed by appropriate scaling. This results in a time-variant perceptual slack values 238, by contrast with traditional time-invariant ESPM techniques. In further embodiments, the allowable perceptual slack module 212 determines perceptual slack values 238 by further identifying a transition frequency or frequency bin, and applying a fixed slack value at frequencies or frequency bins greater than the transition frequency. In some embodiments, transition frequency or frequency bin is identified as described with respect to FIG. 6. In some embodiments, the fixed slack value is identified as described with respect to FIG. 7. In some embodiments, the perceptual slacks and/or the fixed slack value provides a set of maximum perceptual slacks or phase shifts for an audio watermark.

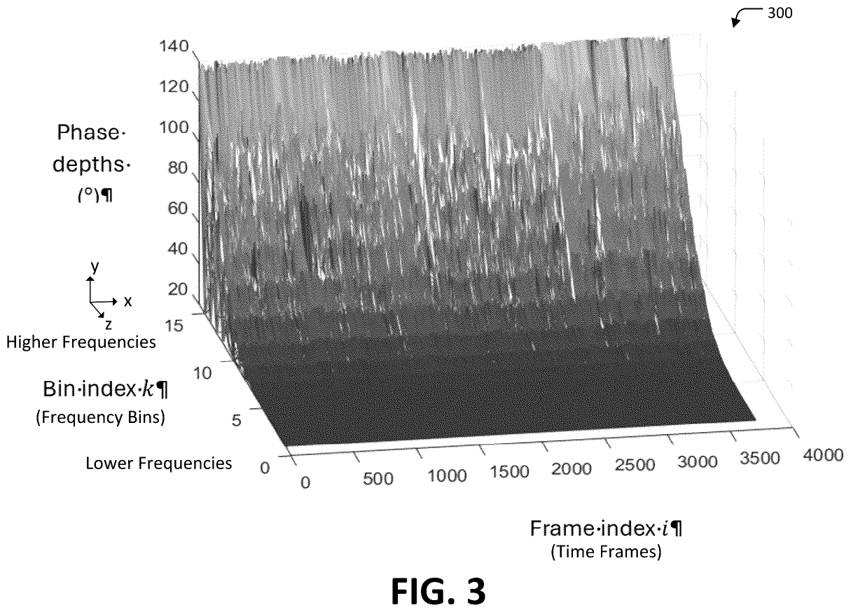

FIG. 3 is a graph 300 illustrating phase depths of audio, according to various embodiments. In graph 300, phase depth magnitudes corresponding to perceptual slack values 238 are shown in a y direction, time frame indices are shown in an x direction, and frequency bin indices are shown in a z direction. In this example, perceptual slack values 238 are higher at higher frequency bins and lower at lower frequency bins. The perceptual slacks also vary for the different frame indices. Accordingly, graph 300 shows time-variant and frequency-variant perceptual slack values 238 for a watermarked audio output 138 that is watermarked by the audio watermarking module 120. In this example, the perceptual slack values 238 are determined by multiplying or otherwise combining the time-invariant ESPM-based phase shifts with the time-variant GM T(s) 234 for each time-frequency bin. This results in time-variant ESPM-based and GMT-based perceptual slack values 238, by contrast with traditional time-invariant ESPM techniques.

FIG. 4 is a graph 400 illustrating phase depths of audio, according to various embodiments. In graph 400, phase depth magnitudes corresponding to perceptual slack values 238 are shown in a y direction, time is shown in an x direction, and frequency is shown in a z direction. Graph 400 shows time-variant and frequency-variant perceptual slack values 238 for a watermarked audio output 138 that is watermarked by the audio watermarking module 120. In this example, the perceptual slack values 238 are determined based on a transition frequency or frequency bin, such that a fixed slack value is applied at frequencies or frequency bins greater than the transition frequency. Here, the fixed slack value corresponds to 180 degrees of phase depth.

FIG. 5 is a flow diagram of method steps for determining perceptual slack, according to various embodiments. Although the method steps are shown in an order, persons skilled in the art will understand that some method steps may be performed in a different order, repeated, omitted, and/or performed by components other than those described in FIG. 5. Although the method steps are described with respect to the systems of FIGS. 1 and 2, persons skilled in the art will understand that any system configured to perform the method steps, in any order, falls within the scope of the various embodiments.

As shown, a method 500 begins at step 502, where the perceptual slack module 124 determines AHTs 230. In some examples, the set of AHTs 230 can be considered to form an AHT curve, whether stored and/or represented as discrete AHT 230 values or a graphical curve shape. The perceptual slack module 124 receives or otherwise identifies audio components 222 of an audio input 136. The audio components 222 are portions of the audio input 136 corresponding to a particular time frames and a particular frequency bin of a set of frequency bins. The perceptual slack module 124 identifies one or more AHTs 230 for each audio component 222. In one embodiment, AHT module 204 identifies AHTs 230 as a function of frequency f based on equation (4). The perceptual slack module 124 normalizes AHTs 230 by adjusting equation (4) so that a signal with a frequency of a particular value and particular amplitude of ±1LSB such as-96 dB lies on an AHT curve of the AHTs 230 over a range of frequencies.

At step 504, the perceptual slack module 124 identifies tonal components 226 and non-tonal components 228 based on the audio components 222. In some embodiments, the perceptual slack module 124 performs steps 502 and 504 with at least partial concurrence. The perceptual slack module 124 receives or identifies input data including audio components 222 of an audio input 136 and MCLT coefficients 224. The perceptual slack module 124 generates tonal components 226 and non-tonal components 228 based on the input data. For example, the tonal analysis module 202 identifies and isolates the tonal components 226 based on the input data. The tonal components 226 are identified as local maxima by comparing the relative amplitudes of an audio component 222 from a particular frequency bin (and time frame) to one or more frequency bins having greater frequencies and one or more frequency bins having lesser frequencies. The tonal components 226 are identified as local maxima based on sound pressure amplitude by comparing the relative amplitudes of the spectrum over adjacent frequency bins, which includes setting a power threshold around a sliding widow of a configured size or number of bins according to equation (3).

At step 506, the perceptual slack module 124 eliminates tonal components 226 and non-tonal components 228 below the corresponding AHTs 230. The perceptual slack module 124 takes inputs including the tonal components 226 and the non-tonal components 228, and provides outputs including respective subsets of the tonal components 226 and the non-tonal components 228. The perceptual slack module 124 eliminates the tonal components 226 and the non-tonal components 228 that have sound pressure levels below the sound pressure level of the AHTs 230 of the corresponding frequencies. Accordingly, the perceptual slack module 124 identifies a subset of the tonal components 226 that is above the sound pressure level of the AHT curve. The perceptual slack module 124 also identifies a subset of the non-tonal components 228 that is above the sound pressure level of the AHT curve. Other audio components 222 are eliminated for the purpose of adding perceptual slack phase shifts.

At step 508, the perceptual slack module 124 identifies component masking parameters 232. The component masking parameters 232 include individual masking thresholds for each of the subset of tonal components 226 and subset of non-tonal components 228. The perceptual slack module 124 determines component masking parameters 232 including masking power for each of the subset of tonal components 226 and subset of non-tonal components 228 for the corresponding frequency index. The perceptual slack module 124 determines component masking parameters 232 including masking indices for each of the subset of tonal components 226 and subset of non-tonal components 228 for the corresponding frequency index. In one example, the tonal masking indices Vₜ are identified using equation (5), and non-tonal masking indices Vₙₜ are identified using equation (6).

At step 510, the perceptual slack module 124 determines the GM Ts 234 T_{g} based on the component masking parameters 232. In some embodiments, the perceptual slack module 124 determines GMTs 234 based on equation (1). The perceptual slack module 124 determines the GMTs 234 for or each of the subset of tonal components 226 and subset of non-tonal components 228 that are greater than the sound pressure levels of the AHTs 230 for corresponding frequencies, thereby reducing resource usage.

At step 512, the perceptual slack module 124 determines perceptual slack values 238 that are allowable based on the GMTs 234, for example, according to equation (2). In some embodiments, the perceptual slack module 124 determines perceptual slack values 238 by further combining GM Ts 234 with ESPM phase shifts, by multiplying them for each time-frequency bin, followed by appropriate scaling. This results in a time-variant perceptual slack values 238, by contrast with traditional time-invariant ESPM techniques. In further embodiments, the perceptual slack module 124 determines perceptual slack values 238 by further identifying a transition frequency or frequency bin, and applying a fixed slack value at frequencies or frequency bins greater than the transition frequency. In some embodiments, the transition frequency or frequency bin is identified as described with respect to FIG. 6. In some embodiments, the fixed slack value is identified as described with respect to FIG. 7. In some embodiments, the perceptual slacks and/or the fixed slack value provides a set of maximum perceptual slacks or phase shifts for an audio watermark.

FIG. 6 is a flow diagram of method steps for determining a transition frequency value or transition frequency bin value k_{c}, according to various embodiments. Although the method steps are shown in an order, persons skilled in the art will understand that some method steps may be performed in a different order, repeated, omitted, and/or performed by components other than those described in FIG. 6. Although the method steps are described with respect to the systems of FIGS. 1 and 2, persons skilled in the art will understand that any system configured to perform the method steps, in any order, falls within the scope of the various embodiments. Generally, the audio watermarking module 120 identifies audio input 136 corresponding to a particular duration of time or time frame, and performs the method 600, repeating the process for each time frame.

As shown, a method 600 begins at step 602, where the audio watermarking module 120 sets the transition frequency bin value k_{c} to an initial bin value ki. Additionally or alternatively, the transition frequency module 128 sets the transition frequency value to an initial frequency value. In some embodiments, the initial bin value ki is a lowest bin value corresponding to the lowest frequencies in a configured frequency range of a set of bin values. However, in other embodiments, the initial bin value ki is a value lower than an expected transition frequency bin value k_{c}, and higher than the lowest bin value.

At step 604, the audio watermarking module 120 determines phase depths corresponding to the perceptual slack, for example, according to equation (2). In some embodiments, the audio watermarking module 120 performs method 500 of FIG. 5. Additionally or alternatively, the audio watermarking module 120 uses the perceptual slack module 124 to perform actions described with respect to FIG. 2.

At step 606, the audio watermarking module 120 generates watermarked audio output 138. The audio watermarking module 120 processes the time-frequency bin corresponding to the time frame under consideration and current frequency bin value k_{c} to generate watermarked audio output 138. The audio watermarking module 120 generates watermarked audio output 138. The watermarked audio output 138 is a processed version of the audio input 136, which is processed to include an audio watermark corresponding to a particular pattern of perceptual slack or phase shifts. In some examples, one or more audio effects are also applied in the audio processing. The audio watermarking module 120 uses the audio input 136 and the perceptual slacks identified in step 604 to generate the watermarked audio output 138.

At step 608, the audio watermarking module 120 determines an imperceptibility score for the watermarked audio output 138 of the time-frequency bin corresponding to the time frame under consideration and current frequency bin value k_{c}. In some embodiments, the imperceptibility score is measured in Perceptual Evaluation of Audio Quality (PEAQ) values or another standardized algorithm for objectively measuring perceived audio quality of the watermarked audio output 138 relative to either the audio input 136 or an unwatermarked version of the watermarked audio output 138, where higher scores indicate better imperceptibility.

At step 610, if the imperceptibility score is less than or equal to a threshold imperceptibility score value, the audio watermarking module 120 increments transition frequency bin value k_{c} to the next bin value. In some examples, the threshold imperceptibility score value corresponds to a value such as −1.0*objective difference grade, or another value. However, any configured threshold imperceptibility score value can be used.

At step 612, the audio watermarking module 120 determines a windowed sidelobe level ratio (wSLR) that is a sidelobe level to noise floor over a small window duration for an estimated cross-correlation. The audio watermarking module 120 determines a wSLR in decibels. A wSLR refers to the ratio of the peak amplitude of a sidelobe in a window centered on the current frequency bin. For example, the audio watermarking module 120 determines a maximum, median, or other measure of amplitude of a current frequency bin. The audio watermarking module 120 determines a maximum, median, or other measure of amplitude of a ‘sidelobe’ corresponding to a set of one or more frequency bin values adjacent to (e.g., at higher and/or lower frequencies) a current frequency bin. The audio watermarking module 120 determines wSLR based on the measure of amplitude of the current frequency bin and the measure of amplitude of the one or more adjacent current frequency bins. In some examples, the audio watermarking module 120 divides the amplitude an adjacent current frequency bin by the amplitude of the current frequency bin.

At step 614, the audio watermarking module 120 determines whether a minimum wSLR value is reached. For example, the audio watermarking module 120 determines a change in wSLR relative to a previous transition frequency bin value k_{c}. If the wSLR change is less than a threshold, then a minimum wSLR is reached. Alternatively, the audio watermarking module 120 determines whether the wSLR (e.g., rather than the change in wLSR) is below a threshold value. If the minimum wSLR value is reached the process moves to step 616. Additionally, if frequency bin value k_{c} is at a predetermined threshold maximum value, then the process moves to step 616. Otherwise, if the minimum wSLR value is not reached and frequency bin value k_{c} is less than a predetermined threshold maximum value, the process moves to step 604 and repeats for an incremented frequency bin value k_{c}.

At step 616, the audio watermarking module 120 finalizes the frequency bin value k_{c} and provides the corresponding watermarked audio output 138 for the time frame. In some embodiments, at frequencies greater than the frequency bin value k_{c}, the watermarked audio output 138 includes a fixed slack value. In some examples, the audio watermarking module 120 generates the watermarked audio output 138 for the time frame once the frequency bin value k_{c} is identified and uses the fixed slack value rather than the slack values identified in step 604. In some embodiments, the perceptual slacks and/or the fixed slack value provides a set of maximum perceptual slacks or phase shifts for an audio watermark.

FIG. 7 is a flow diagram of method steps for determining a fixed slack value vₘ for frequencies greater than the frequency bin value k_{c}, according to various embodiments. Although the method steps are shown in an order, persons skilled in the art will understand that some method steps may be performed in a different order, repeated, omitted, and/or performed by components other than those described in FIG. 7. Although the method steps are described with respect to the systems of FIGS. 1 and 2, persons skilled in the art will understand that any system configured to perform the method steps, in any order, falls within the scope of the various embodiments. Generally, the audio watermarking module 120 identifies audio input 136 corresponding to a particular duration of time or time frame, and performs the method 700, repeating the process for each time frame.

As shown, a method 700 begins at step 702, where the audio watermarking module 120 determines phase depths based on perceptual slack for frequency bin values less than or equal to frequency bin value k_{c}. In some embodiments, the frequency bin value k_{c} is determined according to the method 600 of FIG. 6. The audio watermarking module 120 determines phase depths corresponding to perceptual slack, for example, according to equation (2). In some embodiments, the audio watermarking module 120 performs method 500 of FIG. 5. Additionally or alternatively, the audio watermarking module 120 uses the perceptual slack module 124 to perform actions described with respect to FIG. 2.

At step 704, the audio watermarking module 120 sets an initial slack value vₘ. In some embodiments initial maximum slack value vₘ is a value such as 80°, 90°, 120°, or any other configured “starting” maximum slack value that is less than 180°. In some examples, the audio watermarking module 120 also increments or increases the vₘ value by a predetermined increment such as 1°, 2°, 5° or another selected incremental value.

At step 706, the audio watermarking module 120 determines phase depths based on the fixed slack value vₘ. Audio watermarking module 120 determines the phase depths using equation (2) for frequency bins greater than frequency bin value k_{c}.

At step 708, the audio watermarking module 120 generates watermarked audio output 138. The audio watermarking module 120 processes the time-frequency bin corresponding to the time frame under consideration and current fixed slack value Vₘ to generate a portion of the watermarked audio output 138 for frequency bins greater than frequency bin value k_{c}. The watermarked audio output 138 is a processed version of the audio input 136, which is processed to include an audio watermark corresponding to a particular pattern of perceptual slack or phase shifts. In some examples, one or more audio effects are also applied in the audio processing. The audio watermarking module 120 uses the audio input 136 and the fixed slack value vₘ to generate the watermarked audio output 138.

At step 710, the audio watermarking module 120 determines an imperceptibility score for the portion of the watermarked audio output 138. In some embodiments, the imperceptibility score is measured in PEAQ values or another standardized algorithm for objectively measuring perceived audio quality of the watermarked audio output 138 relative to either the audio input 136 or an unwatermarked version of the watermarked audio output 138, where higher scores indicate better imperceptibility.

At step 712, if the imperceptibility score is less than or equal to a threshold imperceptibility score value, the audio watermarking module 120 increments fixed slack value vₘ by the configured incremental value. In some examples, the threshold imperceptibility score value corresponds to −1.0*objective difference grade, or other value. However, any configured threshold imperceptibility score value can be used.

At step 714, the audio watermarking module 120 determines a wSLR that is a sidelobe level to noise floor over a small window duration for an estimated cross-correlation. The audio watermarking module 120 determines a wSLR in decibels. A wSLR refers to the ratio of the peak amplitude of a sidelobe in a window centered on the current frequency bin. For example, the audio watermarking module 120 determines a maximum, median, or other measure of amplitude of a current frequency bin. The audio watermarking module 120 determines a maximum, median, or other measure of amplitude of a ‘sidelobe’ corresponding to a set of one or more frequency bin values adjacent to (e.g., at higher and/or lower frequencies) a current frequency bin. The audio watermarking module 120 determines wSLR based on the measure of amplitude of the current frequency bin and the measure of amplitude of the one or more adjacent current frequency bins. In some examples, the audio watermarking module 120 divides the amplitude an adjacent current frequency bin by the amplitude of the current frequency bin.

At step 716, the audio watermarking module 120 determines whether a minimum wSLR value is reached. For example, the audio watermarking module 120 determines a change in wSLR relative to a previous fixed slack value vₘ. If the wSLR change is less than a threshold, then a minimum wSLR is reached. Alternatively, the audio watermarking module 120 determines whether the wSLR (e.g., rather than the change in wLSR) is below a threshold value. If the minimum wSLR value is reached the process moves to step 718. Additionally, if frequency bin value k_{c} is at a predetermined threshold maximum value, then the process moves to step 718. Otherwise, if the minimum wSLR value is not reached and frequency bin value k_{c} is less than a predetermined threshold maximum value, the process moves to step 706 and repeats for the next incremental fixed slack value vₘ.

At step 718, the audio watermarking module 120 finalizes the fixed slack value vₘ and utilizes the corresponding watermarked audio output 138 for the time frame. The audio watermarking module 120 generates the watermarked audio output 138 by combining the portion of the watermarked audio output 138 for frequency bins less than or equal to frequency bin value Kc. (e.g., based on step 702) and the portion of the watermarked audio output 138 for frequency bins greater than frequency bin value k_{c} (e.g., based on steps 704-716). In some embodiments, the perceptual slacks and/or the fixed slack value provides a set of maximum perceptual slacks or phase shifts for an audio watermark.

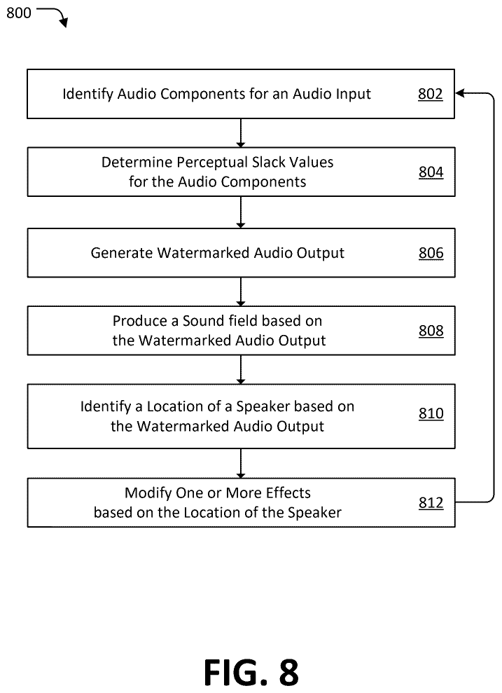

FIG. 8 is a flow diagram of method steps for modifying audio effects, according to various embodiments. Although the method steps are shown in an order, persons skilled in the art will understand that some method steps may be performed in a different order, repeated, omitted, and/or performed by components other than those described in FIG. 8. Although the method steps are described with respect to the systems of FIGS. 1 and 2, persons skilled in the art will understand that any system configured to perform the method steps, in any order, falls within the scope of the various embodiments.

As shown, a method 800 begins at step 802, where the audio processing application 118 identifies audio components 222 for an audio input 136. The audio components 222 are portions of the audio input 136 corresponding to a particular time frame and a particular frequency bin of a set of frequency bins.

At step 804, the audio processing application 118 determines perceptual slack values for the audio components 222. For example, the audio processing application 118 The audio watermarking module 120 determines phase depths corresponding to perceptual slack, for example, based on equation (2). In some embodiments, the audio watermarking module 120 performs method 500 of FIG. 5, method 600 of FIG. 6, and/or method 700 of FIG. 7. Additionally or alternatively, the audio watermarking module 120 uses the perceptual slack module 124 to perform actions described with respect to FIG. 2, in order to determine perceptual slack values for the audio components 222.

At step 806, the audio processing application 118 generates watermarked audio output 138. The audio processing application 118 generates watermarked audio output 138 for a particular time frame. The audio processing application 118 processes the audio input 136 based on perceptual slack values for the audio components 222 to generate the watermarked audio output 138. The watermarked audio output 138 is a processed version of the audio input 136 for the same time frame, which is processed to include an audio watermark corresponding to a particular pattern of perceptual slack or phase shifts.

At step 808, the audio processing application 118 produces a sound field using the watermarked audio output 138. The audio processing application 118 provides the watermarked audio output 138 to the speakers 160 to produce the sound field.

At step 810, the audio processing application 118 identifies locations of the speakers 160 based on the watermarked audio output 138. The audio processing application 118 uses the watermarked audio output 138 and detected audio that is measured using the microphones 150 to identify speaker locations and/or orientations of the speakers 160. For example, the audio processing application 118 compares the known phase depths of the watermarked audio output 138, as determined by the audio watermarking module 120, to the detected audio that is measured using the microphones 150. Device localization module 122 determines speaker locations and/or orientations of the speakers 160 in a three-dimensional space based on the comparison.

At step 812, the audio processing application 118 modifies one or more audio effects based on the locations of the speakers 160. For example, the audio processing application 118 applies and/or updates effects such as spatial up-mixing based on the locations of the speakers 160. The audio processing application 118 the returns to step 802 to continue with respect to the audio input 136 for the next time frame. In some embodiments, the audio processing application 118 performs method 800 for two or more time frames with at least partial concurrence. In such embodiments, the audio processing application 118 moves to step 802 for a next time frame during or after any of steps 802-812 for one or more previous time frames.

In sum, techniques are disclosed for audio watermarking using hybrid masking threshold-based perceptual slacks. The described techniques enable calibration procedures that are automatically performed and inaudible to users, ensuring that the audio systems produce the desired effects such as spatial up-mixing. The described techniques are also iteratively performed over time to enable real-time processing using time-variant and frequency-variant audio watermarking. The described techniques include receiving an audio signal, analyzing the audio signal to determine a perceptual slack of the audio signal, determining one or more audio watermarks to add to the audio signal based on the perceptual slack, adding the one or more audio watermarks to the audio signal to generate a watermarked audio signal, and outputting the watermarked audio signal using one or more speakers.

At least one technical advantage of the disclosed techniques relative to the prior art is that the disclosed techniques enable localization of audio devices such as speakers using a listener-imperceptible audio watermarking. Specifically, the disclosed techniques increase the detectability of audio watermarks while keeping the watermark imperceptible to a listener. This enhanced watermarking improves localization, thereby improving audio quality and efficacy of effects produced by the system. The disclosed techniques also enable imperceptible speaker localization without user intervention or initiation, ensuring that the system completes the localization. The disclosed techniques further provide time-variant and frequency-variant imperceptible watermarking. These technical advantages represent one or more technological improvements over prior art approaches.
1. In some embodiments, a computer-implemented method for watermarking audio comprises receiving an audio signal, analyzing the audio signal to determine perceptual slacks of the audio signal, determining one or more audio watermarks to add to the audio signal based on the perceptual slacks, adding the one or more audio watermarks to the audio signal to generate a watermarked audio signal, and outputting the watermarked audio signal using one or more speakers.
2. The computer-implemented method of clause 1, wherein analyzing the audio signal to determine the perceptual slacks comprises estimating tonal components of the audio signal to identify local peaks over short window lengths.
3. The computer-implemented method of clauses 1 or 2, wherein the perceptual slacks are determined based on global masking thresholds.
4. The computer-implemented method of any of clauses 1-3, wherein the global masking thresholds are determined based on component masking parameters for a subset of audio components of the audio signal, wherein the subset of audio components identified based on absolute hearing thresholds for the audio components.
5. The computer-implemented method of any of clauses 1-4, wherein analyzing the audio signal to determine the perceptual slacks comprises determining a first subset of the perceptual slacks for lower frequencies based on the global masking thresholds, and determining a second subset of the perceptual slacks for higher frequencies based on a fixed perceptual slack value.
6. The computer-implemented method of any of clauses 1-5, further comprising determining a transition frequency or transition frequency bin based on one or more imperceptibility scores for watermarked audio generated at one or more frequencies or frequency bins of the audio signal.
7. The computer-implemented method of any of clauses 1-6, wherein the transition frequency or transition frequency bin corresponds to a border between the first subset of the perceptual slacks and the second subset of perceptual slacks.
8. The computer-implemented method of any of clauses 1-7, wherein determining the transition frequency or transition frequency bin further comprises determining whether a windowed sidelobe level ratio (wSLR) is minimized.
9. The computer-implemented method of any of clauses 1-8, further comprising determining the fixed perceptual slack value based on one or more imperceptibility scores for watermarked audio generated at one or more frequencies or frequency bins of the audio signal.
10. The computer-implemented method of any of clauses 1-9, wherein determining the fixed perceptual slack value further comprises determining whether a windowed sidelobe level ratio (wSLR) is minimized.
11. The computer-implemented method of any of clauses 1-10, further comprising identifying a location of a speaker based on one or more measurements of a sound field of the watermarked audio signal, and modifying at least one spatial effect based on the location of the speaker.
12. In some embodiments, one or more non-transitory computer-readable media store instructions that, when executed by one or more processors, cause the one or more processors to perform the steps of identifying an audio signal, determining perceptual slacks for the audio signal, generating a watermarked audio signal based on the audio signal, the watermarked audio signal comprising an audio watermark based on the perceptual slacks, and outputting the watermarked audio signal using one or more speakers.
13. The one or more non-transitory computer-readable media of clause 12, wherein the watermarked audio signal comprises a time-variant exponentially smoothed phase modulation (ESPM)-based watermark.
14. The computer-implemented method of clauses 12 or 13, wherein the perceptual slacks are determined based on global masking thresholds.
15. The computer-implemented method of any of clauses 12-14, wherein the global masking thresholds are determined based on component masking parameters for a subset of audio components of the audio signal, wherein the subset of audio components identified based on absolute hearing thresholds for the audio components.
16. The computer-implemented method of any of clauses 12-15, wherein determining the perceptual slacks comprises determining a first subset of the perceptual slacks based on the global masking thresholds, and determining a second subset of the perceptual slacks based on a fixed perceptual slack value.
17. The computer-implemented method of any of clauses 12-16, further comprising determining a transition frequency or transition frequency bin based on one or more imperceptibility scores for watermarked audio generated at one or more frequencies or frequency bins of the audio signal, wherein the transition frequency or transition frequency bin corresponds to a border between the first subset of the perceptual slacks and the second subset of perceptual slacks.
18. The computer-implemented method of any of clauses 12-17, further comprising determining the fixed perceptual slack value based on one or more imperceptibility scores for watermarked audio generated at one or more frequencies or frequency bins of the audio signal.
19. The computer-implemented method of any of clauses 12-18, wherein determining the fixed perceptual slack value further comprises determining whether a minimum windowed sidelobe level ratio (wSLR) is reached.
20. In some embodiments, a system comprises one or more speakers, a memory storing instructions, and one or more processors, that when executing the instructions, are configured to perform the steps of receiving an audio signal, analyzing the audio signal to determine perceptual slacks for the audio signal, adding an audio watermark to the audio signal to generate a watermarked audio signal, wherein the audio watermark is based on the perceptual slacks, and localizing the one or more speakers based on a sound field generated by outputting the watermarked audio signal using the one or more speakers.

The descriptions of the various embodiments have been presented for purposes of illustration, but are not intended to be exhaustive or limited to the embodiments disclosed. M any modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

Flowcharts and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for watermarking audio, comprising:
receiving an audio signal;
analyzing the audio signal to determine perceptual slacks of the audio signal;
determining one or more audio watermarks to add to the audio signal based on the perceptual slacks;
adding the one or more audio watermarks to the audio signal to generate a watermarked audio signal; and
outputting the watermarked audio signal using one or more speakers.

2. The computer-implemented method of claim 1, wherein analyzing the audio signal to determine the perceptual slacks comprises estimating tonal components of the audio signal to identify local peaks over short window lengths.

3. The computer-implemented method of claim 1, wherein the perceptual slacks are determined based on global masking thresholds.

4. The computer-implemented method of claim 3, wherein the global masking thresholds are determined based on component masking parameters for a subset of audio components of the audio signal, wherein the subset of audio components identified based on absolute hearing thresholds for the audio components.

5. The computer-implemented method of claim 3, wherein analyzing the audio signal to determine the perceptual slacks comprises:
determining a first subset of the perceptual slacks for lower frequencies based on the global masking thresholds, and
determining a second subset of the perceptual slacks for higher frequencies based on a fixed perceptual slack value.

6. The computer-implemented method of claim 3, further comprising determining a transition frequency or transition frequency bin based on one or more imperceptibility scores for watermarked audio generated at one or more frequencies or frequency bins of the audio signal.

7. The computer-implemented method of claim 6, wherein the transition frequency or transition frequency bin corresponds to a border between the first subset of the perceptual slacks and the second subset of perceptual slacks.

8. The computer-implemented method of claim 6, wherein determining the transition frequency or transition frequency bin further comprises determining whether a windowed sidelobe level ratio (wSLR) is minimized.

9. The computer-implemented method of claim 3, further comprising determining the fixed perceptual slack value based on one or more imperceptibility scores for watermarked audio generated at one or more frequencies or frequency bins of the audio signal.

10. The computer-implemented method of claim 9, wherein determining the fixed perceptual slack value further comprises determining whether a windowed sidelobe level ratio (wSLR) is minimized.

11. The computer-implemented method of claim 1, further comprising:
identifying a location of a speaker based on one or more measurements of a sound field of the watermarked audio signal; and
modifying at least one spatial effect based on the location of the speaker.

12. One or more non-transitory computer-readable media storing instructions that, when executed by one or more processors, cause the one or more processors to perform the steps of:
identifying an audio signal;
determining perceptual slacks for the audio signal;
generating a watermarked audio signal based on the audio signal, the watermarked audio signal comprising an audio watermark based on the perceptual slacks; and
outputting the watermarked audio signal using one or more speakers.

13. The one or more non-transitory computer-readable media of claim 12, wherein the watermarked audio signal comprises a time-variant exponentially smoothed phase modulation (ESPM)-based watermark.

14. The computer-implemented method of claim 12, wherein the perceptual slacks are determined based on global masking thresholds.

15. The computer-implemented method of claim 14, wherein the global masking thresholds are determined based on component masking parameters for a subset of audio components of the audio signal, wherein the subset of audio components identified based on absolute hearing thresholds for the audio components.

16. The computer-implemented method of claim 14, wherein determining the perceptual slacks comprises:
determining a first subset of the perceptual slacks based on the global masking thresholds, and
determining a second subset of the perceptual slacks based on a fixed perceptual slack value.

17. The computer-implemented method of claim 14, further comprising determining a transition frequency or transition frequency bin based on one or more imperceptibility scores for watermarked audio generated at one or more frequencies or frequency bins of the audio signal, wherein the transition frequency or transition frequency bin corresponds to a border between the first subset of the perceptual slacks and the second subset of perceptual slacks.

18. The computer-implemented method of claim 12, further comprising determining the fixed perceptual slack value based on one or more imperceptibility scores for watermarked audio generated at one or more frequencies or frequency bins of the audio signal.

19. The computer-implemented method of claim 18, wherein determining the fixed perceptual slack value further comprises determining whether a minimum windowed sidelobe level ratio (wSLR) is reached.

20. A system comprising:
one or more speakers;
a memory storing instructions; and
one or more processors, that when executing the instructions, are configured to perform the steps of:
receiving an audio signal;
analyzing the audio signal to determine perceptual slacks for the audio signal;
adding an audio watermark to the audio signal to generate a watermarked audio signal, wherein the audio watermark is based on the perceptual slacks; and
localizing the one or more speakers based on a sound field generated by outputting the watermarked audio signal using the one or more speakers.
